(19) United States
(12) Patent Application Publication
(10) Pub. No.: US 2019/0276328 A1
(43) Pub. Date: Sep. 12, 2019

(54) METHOD FOR THE PRODUCTION OF LITHIUM CARBONATE FROM SALT BRINES

(71) Applicant: MGX MINERALS INC., Vancouver (CA)

(72) Inventors: Jared LAZERSON, Vancouver (CA); Anita MARKS, Gold Canyon, AZ (US)

(21) Appl. No.: 16/348,109

(22) PCT Filed: Nov. 1, 2017
(86) PCT No.: PCT/CA2017/000237

§ 371 Date: May 7, 2019

Related U.S. Application Data
(60) Provisional application No. 62/419,011, filed on Nov. 8, 2016.

(51) Int. Cl. C01D 15/08; C01F 11/32; C01D 3/06; C01F 11/46; C01F 5/14

(52) U.S. Cl. CPC C01D 15/08; C01F 11/32; C01F 5/145; C01F 11/468; C01D 3/06

(57) ABSTRACT

A process for extracting lithium from lithium-bearing salt brines including: (i) subjecting a feed brine to a primary evaporation step using mechanical evaporators, to form a first concentrated brine and sodium chloride; (ii) separating the sodium chloride in a salt removal step; (iii) reacting lime with the first concentrated brine in a liming step to precipitate out and discard magnesium and sulphate ions and other contaminants and to form a limed brine; (iv) subjecting the limed brine to a secondary evaporation step, to form a second concentrated brine and precipitating calcium chloride; (v) separating the calcium chloride from the second concentrated brine; (vi) reacting sodium sulphate with the second concentrated brine to precipitate out and discard calcium sulphate, to form a lithium-rich brine; (vii) reacting soda ash with the lithium rich brine thereby forming a precipitate of lithium carbonate; and (viii) separating the lithium carbonate.

### FIELD OF THE INVENTION

The present invention relates to methods for extracting lithium salts from salt brines. More particularly, the present invention relates to a process for treating lithium-bearing salt brines in order to rapidly produce lithium carbonate (along with other commercially useful products).

### BACKGROUND OF THE INVENTION

There are a large number of commercial applications for lithium, lithium minerals and lithium salts, including in the electronic, pharmaceutical, ceramic and lubricant industries. Commercial applications include, but are not limited to, use in batteries, use in lubricant greases, industrial catalysts, use in the manufacture of glass and ceramics, use in aluminum metallurgy and in the steel industry, use in the sterilization of water for swimming pools, and use in organic chemical synthesis as a reducing agent. It is contemplated that lithium will play a significant part in the development of batteries for electrical vehicles, which alone may greatly impact the future demand for lithium.

Given this growing importance of lithium, it is highly desirable to find good sources of lithium and to find economically viable methods for the production thereof.

Natural salt brines have conventionally been used as a source of lithium (e.g. certain salt brine deposits in South America in particular have been utilised as a source of lithium or lithium salts, since they contain relatively significant amounts/concentrations of lithium).

Another potential source of lithium is from industrial salt brines. For example, such industrial brines may include oilfield brines, which is a term often used to refer to the oil-free water produced from the central processing facility of a petroleum operator's oil-well operations.

In the case of lithium extraction from natural salt brines, conventionally the brine is first pooled in evaporation ponds and much of the water evaporated therefrom using solar evaporation in order to concentrate the brine and/or to precipitate out the salt solids. This concentration step is typically necessary to allow effective processing of the salts in the salt brine, particularly when the concentration of the target salt(s) is low.

By way of background, for example, U.S. Pat. No. 5,993,759 discloses a process for producing lithium carbonate from brines, which includes as part of the process, a step to remove boron from the feed brine, by acidifying the feed brine to form boric acid, which can be removed from the brine. Following this, the brine is diluted, and then a step for removing the magnesium from the brine is provided, and then finally, sodium carbonate is added to precipitate lithium carbonate. Diluting the boron-free brine, results in the reduction of co-precipitation of lithium carbonate during the magnesium removal step, thus improving the recovery and purity of the lithium carbonate. This patent discusses some of the known methods for extracting lithium from salt brines, including treating brines through solar evaporation in brine pools (before further processing said brines), in order to increase the lithium content.

U.S. Pat. No. 6,143,260 discloses a method for producing lithium carbonate by precipitating magnesium as magnesium hydroxide, from a brine that has been concentrated to a lithium concentration of about 6%. The lithium is precipitated from the brine by addition of mother liquor from a previous lithium precipitation step.

U.S. Pat. No. 8,691,169 discloses a process for producing battery grade metallic lithium from naturally occurring or industrial brines, involving (i) precipitating magnesium with calcium hydroxide; (ii) removing boron via extraction of solvents; (iii) precipitating lithium carbonate; (iv) adding carbonic acid to transform lithium carbonate to bicarbonate of lithium; (v) heating the solution to decompose the bicarbonate of lithium into high purity lithium carbonate. The step of re-precipitating the lithium carbonate via formation of bicarbonate of lithium allows for the removal of the majority of contaminants which co-purify with lithium carbonate.

The disadvantages of using solar evaporation in evaporation ponds include the fact that a very large area of land would be required to accommodate the evaporation ponds (hence expensive, and not environmentally friendly), and this likely would only be feasible in locations with suitable conditions (sunshine, warm temperatures, wind, dryness, etc.). Furthermore, considerable lead time (anywhere from several months to over a year) would likely be required before sufficient evaporation occurs to start producing sufficient amounts of the concentrated salt brine, so that further processing can even take place; thus, for any such lithium-extraction-from-salt-brine project, it might well take many months to years, following completion of the processing plant itself, to start producing significant amounts of saleable lithium salt product and generating revenue.

Thus, it is desirable to develop a process for extracting lithium from salt brines which does not rely on solar evaporation from ponds. It would also be advantageous to provide a process which does not require a lengthy period of waiting for salts/precipitates to be produced from the salt brine, but which rather can start producing relatively quickly and continuously.

Known conventional processes for extracting lithium from salt brines have limitations in terms of their economic viability. This is due to a number of factors, including the relatively low concentration of lithium content, the amount of useful lithium that can be extracted, the operating costs of the process, etc. This is particularly marked where the salt brine in question has a relatively low lithium concentration. Thus, it would be desirable to have a process to extract lithium from salt brines which is cost effective. Since it is recognized that (particularly when dealing with starting brines which are relatively low in concentration of lithium) a potential issue is that the commercial value of the lithium carbonate that can be produced may not be enough to make such a project economically viable (or even if the project is viable, the margins would be modest), therefore, it would be desirable to develop a lithium-from-salt-brine process which also produces other commercially useful and saleable products besides lithium carbonate, in order to improve the economic viability of the overall process.

### BRIEF SUMMARY OF THE INVENTION

Disclosed herein is a process in which industrial salt brines having modest concentrations of lithium, may be utilized to produce lithium carbonate (Li₂CO₃). Mechanical evaporators are used to remove water from and concentrate the salt brines in an initial or primary evaporation step, which is used in place of the conventional solar evaporation ponds. The mechanical evaporators can take various forms known in the art (including for example fans, blowers, dryers, etc.); generally speaking, these use some form of energy transfer process (e.g. using air movement or heat, or a combination thereof) to evaporate the target constituent, which in the present case is mainly water. In order to make the overall process viable (or to improve its economic viability), the process also produces several other desirable and commercially salable by-products, namely sodium chloride (NaCl) and calcium chloride (CaCl₂). The sodium chloride and calcium chloride may be collected and sold separately.

In accordance with an aspect of the present invention, disclosed herein is a process for extracting lithium from lithium-bearing salt brines comprising: (i) subjecting a feed brine containing lithium to a primary evaporation step, wherein a plurality of mechanical evaporators are used to evaporate water from the feed brine, thereby forming a first concentrated brine and sodium chloride solids; (ii) separating the sodium chloride solids from the first concentrated brine in a salt removal step; (iii) reacting lime with the first concentrated brine in a liming step, thereby forming a limed brine and a first discard precipitate comprising magnesium hydroxide, calcium sulphate and other contaminants; (iv) subjecting the limed brine to a secondary evaporation step, thereby forming a second concentrated brine and precipitating calcium chloride solids; (v) separating the calcium chloride solids from the second concentrated brine; (vi) reacting sodium sulphate with the second concentrated brine, thereby forming a lithium-rich brine and a second discard precipitate comprising calcium sulphate; (vii) reacting soda ash with the lithium-rich brine, thereby forming a precipitate of lithium carbonate; and (viii) separating the lithium carbonate.

In a preferred embodiment, it is contemplated that the plant embodying the present process would be designed to operate continuously, around the clock.

In accordance with another aspect, prior to step (i), the feed brine may be pre-heated in a preheating step, using steam (preferably recycled from the primary and secondary evaporation steps). Preferably, the feed brine is pre-heated to a temperature of between 190° F. to 212° F., and most preferably to a temperature of around 190° F.1

In accordance with another aspect, it is contemplated that in step (vi), sodium sulphate may be replaced with soda ash, to form a precipitate of calcium carbonate in the second calcium removal step. Alternatively, a mixture of soda ash and sodium sulphate could also be used to precipitate out the calcium.

In accordance with another aspect, it is further contemplated that other potentially saleable by-products produced by the process (besides sodium chloride, calcium chloride and lithium carbonate), may also be collected and sold, such as potassium, boron, bromine and strontium products.

### BRIEF DESCRIPTION OF THE DRAWINGS

Embodiments of the present invention are described below with reference to the accompanying drawings in which:

FIG. 1 is a simplified flowchart illustrating the process in accordance with one aspect of the present invention.

FIGS. 2A and 2B represent a flowchart illustrating the process in accordance with an aspect of the present invention.

### DETAILED DESCRIPTION OF THE INVENTION

The present invention now will be described more fully hereinafter with reference to the accompanying drawing(s), which form a part hereof, and which show, by way of illustration, exemplary embodiments by which the invention may be practiced. The invention may, however, be embodied in many different forms and should not be construed as limited to the embodiments set forth herein; rather, these embodiments are provided so that this disclosure will be thorough and complete, and will fully convey the scope of the invention to those skilled in the art. The following detailed description is, therefore, not to be taken in a limiting sense.

The present invention will be discussed and illustrated herein in the context of a process for extracting lithium (in the form of lithium carbonate) from oilfield brine. It should be understood, however, that the disclosed process may also be applied to the processing of any lithium-bearing salt brines (whether natural or industrial). Such oilfield brine, besides containing lithium, typically includes significant amounts of sodium, calcium and magnesium, as well as other ions. Where the salt brine contains significant amounts of sodium, calcium and/or magnesium, this can further negatively impact the overall economic viability of a lithium extraction project, since considerable efforts and resources may be required to process and remove these and other ions. Indeed, taking into account the typically modest concentrations of lithium content in the starting brines and the modest margins, the costs associated with further processing to remove calcium alone, may render such a lithium extraction project unviable.

An investigation into the oilfield brines in several certain locations, such as those located in the Foxcreek region of Alberta, Canada, and the Smackover Formation of East Texas and Arkansas, indicated that these brines contained moderate (but not insignificant) amounts of lithium content. By way of example, a sample analysis of a number of such oilfield brines indicated relative compositions as follows:

TABLE 1
Starting Brine Compositions

| | |
|---|---|
| Specific Gravity | 1.14 |
| K (mg/L) | 5,100 |
| Mg (mg/L) | 2,010 |
| Na (mg/L) | 54,000 |
| Cl (mg/L) | 125,100 |
| Ca (mg/L) | 15,900 |
| SO₄ (mg/L) | 155 |
| Sr (mg/L) | 630 |
| B (mg/L) | 260 |
| Br (mg/L) | 426 |
| Li (mg/L) | 130 |

A further potential benefit of applying the present process to industrial/oilfield brines, such as those in the Alberta and Texas oilfields, is the availability of relatively low cost energy and heating sources (such as natural gas), as well as steam from new and existing industrial plants, all of which may be used within parts of the process to improve the efficiencies of the overall process. A further benefit is that these locations may also provide close proximity to a ready market for the lithium carbonate and saleable by-products (and/or to the infrastructure that can facilitate the access to appropriate such markets); this is usually not the case for the processing plants for the conventional lithium-bearing, natural brines, which are typically situated in very remote locations.

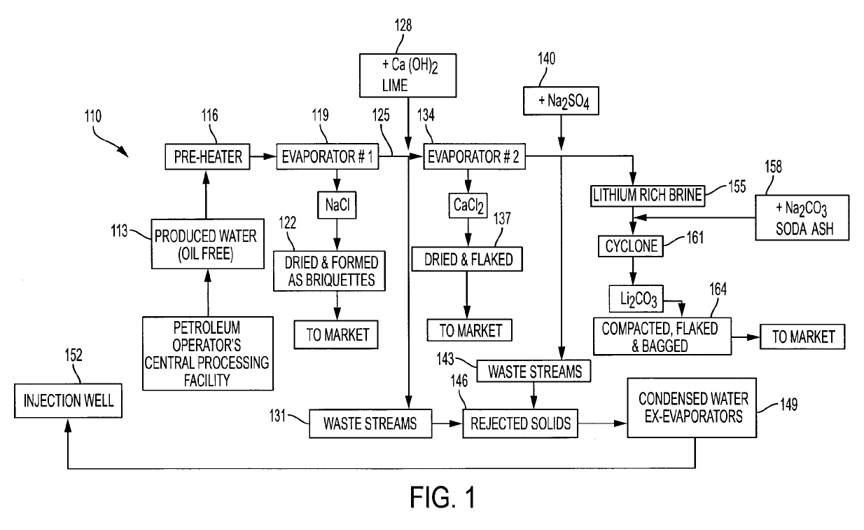

Referring to FIG. 1, this is a simplified flowchart setting out an exemplary process 110 in accordance with an aspect of the present invention.

The overall process may be outlined as follows.

1. Evaporate (primary) the starting or feed brine using mechanical evaporators to remove ˜60-90% of the water and form NaCl(s).
2. Cyclone, centrifuge, wash, dry, briquette and store the resulting NaCl.
3. Add lime (Ca(OH)₂) to the remaining brine to precipitate out magnesium ions, sulphate ions and other contaminants.
4. Cyclone, centrifuge and wash these solids for discard.
5. Evaporate (secondary) brine further to concentrate brine and precipitate CaCl₂.
6. Produce CaCl₂ flake—dry and store (removes ˜80% of calcium ions).
7. Add Na₂SO₄ to resulting brine to precipitate remaining 20% of calcium ions as calcium sulphate.
8. Cyclone the precipitate from secondary evaporation, centrifuge, wash solids and send (along with those from step 4) to discard.
9. Discard solids, along with condensed water from evaporation steps, to brine injector well.
10. Brine from secondary evaporation is treated with soda ash (Na₂CO₃) to precipitate Li₂CO₃.
11. Cyclone, centrifuge, wash, dry, compact and bag Li₂CO₃ for sale.

The feed or starting brine 113 in the present illustration is oilfield brine produced from a petroleum operator's central processing facility. This oilfield brine 113 is oil-free, since it has undergone processing and filtration to remove any oil and hydrocarbon products, metals or chemicals, that may interfere with the present process, as well as to potentially reduce the water content of the raw brine.

It is highly preferable that the feed brine 113 be substantially free from oil and hydrocarbon products, as the presence thereof can contaminate the equipment in the downstream processes, which may require frequent cleaning of such equipment and/or that the plant be shut down altogether for such cleaning. Further, depending on the quality of the feed brine, it is also contemplated that conventional filtration techniques may be applied (not shown) to pre-treat the starting brine. Such filtration techniques may be applied to remove physical and crystallized particulates, and other colloids, minerals and crystallized metals from the feed brine 113.

Further, it should also be appreciated that conventional filtration techniques may alternatively be applied to the process brine at any of a number of steps throughout the overall process described below, in order to remove undesirable impurities within the process. Generally, such filtration techniques are omitted in order to maintain a free flow of the process brine. However, such conventional filtration steps may on the other hand result in increases in efficiency and reduction in capital costs, e.g. by decreasing the size/number of the evaporators required. The removal of impurities through filtration may improve overall efficiency, improve product crystallization processes, improve the recovery of products/by-products, and potentially reduce the amount of reagents and evaporation required.

For improved operational efficiency of the overall process, the feed brine 113 is fed into a preheater or heat exchanger in order to undergo a preheating step 116 in preparation for the following primary evaporation step 119. In the preheating step 116, the feed brine 113 is heated to a temperature close to the operational temperature of the primary evaporation step 119. In a preferred embodiment, the preheating step 116 may involve the use of recycled steam that is generated from (or shared with) other parts of the overall process.

A key cost and process design consideration is the step of concentrating the salt brine to precipitate/crystallize solid salts. All told, in the overall process, approximately over 98% of the starting water from the feed brine 113 has to be evaporated. Due to the previously mentioned limitations of using solar evaporation ponds, it was contemplated that there may be advantages in using mechanical evaporation instead. The use of mechanical evaporation methods as the primary evaporation step of lithium salt brines would not conventionally be considered practicable given the typically low margins involved in lithium extraction and the fact that operating such mechanical evaporation methods would necessarily introduce additional energy costs. However, it has been determined that this can work in the appropriate circumstances. Producing oil and gas fields provide both access to lithium-bearing brine and access to low cost thermal energy sources such as natural gas and secondary steam from existing refineries, upgraders, and industrial plants. As such, the present process utilizes mechanical evaporators in the primary evaporation step 119.

Steam vapour (for example, steam generated using a steam boiler or hot oil heater) is applied to bring the preheated brine close to evaporation temperature. Mechanical evaporators are then applied to drive off water from the brine. In the primary evaporation step 119, a number of mechanical evaporators are employed to evaporate approximately between 60-90% of the water in the feed brine 113.

The preferred or optimum temperature and conditions for the primary evaporation step 119 can be determined by a person skilled in the art, taking into account factors such as the salt concentration of the feed brine, external conditions, and the desired rate of primary evaporation. However, it is contemplated that the feed brine 113 is heated up to around 190-212° F. (around the boiling point of water) during this primary evaporation step. Once the process brine is heated to this temperature, it is generally maintained at or close to about 200° F. throughout the downstream processes. As such, the reaction temperatures of such subsequent process steps described below are not generally specified herein. For greater efficiency, efforts should be made to minimise heat losses from the system, such as using appropriate insulation and providing containment lids on mix tanks, etc. In a preferred embodiment of the present system, it is only at the downstream steps where various solid products are cyclone/centrifuged/dried (e.g. NaCl, CaCl₂, and Li₂CO₃, as described later), that process temperatures might reach up to around 325° F.

The evaporator may be in the form of a conventional multiple-effect evaporator. This is an apparatus that is used for efficiently using the heat from steam to evaporate water. In a multiple-effect evaporator, water is typically boiled in a sequence of vessels, each held at a lower pressure than the last. Because the boiling temperature of water decreases as pressure decreases, the vapor boiled off in one vessel can be used to heat the next, and only the first vessel (at the highest pressure) requires an external source of heat. In a preferred embodiment, forward-feed four-effect evaporators may be utilised.

Depending on the conditions, it is approximately at this stage that enough water is driven off from the feed brine 113, that sufficient sodium chloride (NaCl) starts to crystallize and form from the concentrated brine. The solid sodium chloride collected preferably may be cycloned, centrifuged, washed, dried or compacted (or combinations thereof) accordingly. The sodium chloride can then be collected for commercial sale. Preferably, the sodium chloride can be formed into briquettes (step 122) to facilitate such further sale.

The remaining brine from the primary evaporation step 119 (sometimes referred to herein as a first concentrated brine 125) is passed into a mix tank or reaction chamber, and is treated with lime (Ca(OH)₂) in a liming step 128, and mixed therewith. The lime may be in the form of slaked lime, preferably a saturated slaked lime solution. In this liming step 128, the lime serves to react with and precipitate magnesium (Mg²⁺) ions and sulphate (SO₄²) in the brine as follows:

Mg²⁺(aq)+Ca(OH)₂→Mg(OH)₂(s)+Ca²⁺ (1)

SO₄²⁻(aq)+Ca(OH)₂→CaSO₄(s) (2)

The primary purpose of the lime in this step is to remove magnesium and sulphate ions (given their relatively more significant concentrations). However, the lime may also react with and precipitate other contaminants, such as, strontium and boron.

e.g. Sr²⁺(aq)+Ca(OH)₂→Sr(OH)₂(s) (3)

Boron may, for example, react with the lime to form boric acid or calcium borates

e.g. B³⁺+Ca(OH)₂→B(OH)₃(s) (boric acid) (4)

An amount of Ca(OH)₂ in sufficient quantities to react with and precipitate out the magnesium, sulphate and other “contaminant” ions is used. It is understood that an approximately stoichiometric (or slightly in excess) amount of Ca(OH)₂ would be required to fully react with the amount of magnesium, sulphate, and other ions. These precipitated solids may be collected and fed into waste streams (step 131), where they are sent off for discard (step 146). Preferably, these solids may be cycloned, centrifuged and/or washed, before being sent off for discard.

The remaining brine from the liming step 128 (sometimes referred to herein as the limed brine) is then subjected to a secondary evaporation step 134 using mechanical evaporators. This step serves in part to concentrate the lithium content. Calcium chloride is likely to be a significant component in the remaining brine, and will be in solution. Calcium chloride has commercial value, and has quite a number of commercial/industrial uses (for deicing, for water treatment, as a chemical reagent, etc.). The secondary evaporation step 134 also serves to concentrate the calcium chloride. This brine is subjected to air cooling so that calcium chloride crystalizes out of the brine (including e.g. calcium chloride in dihydrate form, and calcium chloride in monohydrate form). This step removes much of, but not all, the calcium ions that are in the brine. Approximately up to 80% of the calcium content in the brine can be removed as calcium chloride in this step. The calcium chloride is preferably dried (e.g. using a dryer/kiln) and flaked (using conventionally known methods), and/or stored, following which it can be commercially sold.

The remaining brine from the secondary evaporation step 134 (sometimes referred to herein as a second concentrated brine) is then passed into a mix tank, and reacted with sodium sulphate (Na₂SO₄) in a further calcium removal step 140. As described above, up to approximately 80% of the calcium content then in the brine may be removed as calcium chloride following the secondary evaporation step 134. The remaining amount of calcium ions (approximately 20%) reacts with the sodium sulphate to form a precipitate of calcium sulphate. In addition, besides calcium sulphate, other unwanted solids may be formed from this step, such as KCl, NaCl and Mg(OH)₂. The precipitate and solids may be collected and fed into waste streams (step 143), where they are sent off for discard (step 146). Preferably, the precipitate solids may be cycloned, centrifuged and/or washed, before being sent off for discard. As an alternative to sodium sulphate, it is contemplated that soda ash (sodium carbonate) could also be used in this further calcium removal step 140; in this case, the precipitate formed would be calcium carbonate. Sodium sulphate is generally preferred over soda ash in preferred embodiments for a number of reasons, including its relative lower cost.

The remaining lithium-rich brine 155 from the further calcium removal step 140 is then passed into a further mix tank, where it is heated, preferably to around 200° F. Soda ash (Na₂CO₃) is added to this mix tank (step 158). Optionally, the soda ash may be generated within the plant using the Solvay process (in which sodium chloride and calcium carbonate is reacted together to form soda ash and calcium chloride). The lithium ions in the lithium-rich brine 155 react with the soda ash to form lithium carbonate (Li₂CO₃). This product may be centrifuged, washed, dried (step 161), compacted and bagged (step 164) for sale. Any remaining brine may be recycled back to the start of the process (not shown).

It is to be appreciated that operational and cost efficiency is key to the economic viability of the process of the present invention. As such, steps that may be utilised to minimise heat/energy loss (e.g. using heat exchangers), or steps to recover heat from waste streams, or steps taken to minimise wastage, etc. will be beneficial to the overall process. Accordingly, for example, water from the evaporation steps may be collected, and condensed in order to recover as much system heat as possible (approximately 85% or more)(step 149), before it is released back to the brine and then injected via an injection well (step 152).

Although not specifically mentioned above, displacement washes may be utilized on pusher centrifuges in order to remove brine from centrifuge cakes, since otherwise too much lithium would be lost to centrifuge cakes and the lithium cake would not be pure enough for commercial sales.

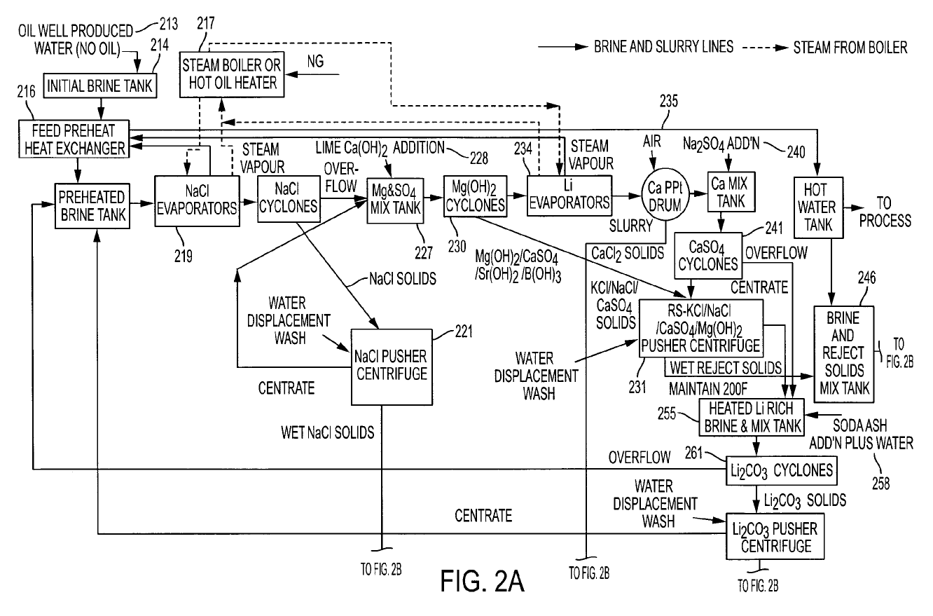

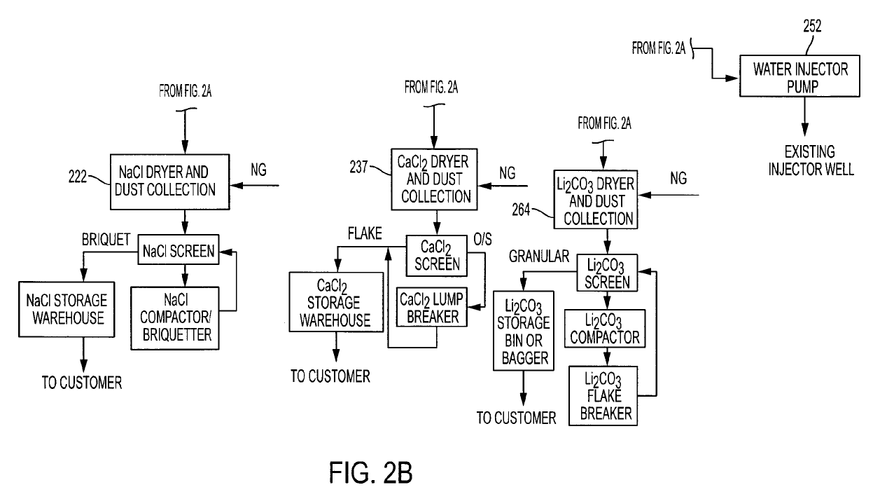

Referring to FIGS. 2A and 2B, these represent a flowchart (which has been split apart for ease of presentation) illustrating a more detailed embodiment of the present invention. This presents more detail regarding a specific embodiment of the present invention, and also includes some aspects of how a plant embodying the process may be arranged. This layout illustrates how various steps in the process might be suitably arranged to provide for greater efficiencies. The overall process presented is along the lines of that discussed above for FIG. 1. The feed brine 213 is fed into the plant where it may be stored in an initial brine tank 214. This feed brine 213 is passed into a preheat heat exchanger of preheater 216. The heat for the preheater may come from steam generated by a steam boiler or hot oil heater 217 (preferably, where available, natural gas may be used to provide the energy source to power the boiler/heater 217). As shown in FIG. 2, the steam/heat may be shared with or recycled from other parts of the process (e.g. the downstream evaporators). The brine is treated in a primary evaporation step 219 (involving a number of mechanical evaporators). The sodium chloride crystallized from this step can be passed to a sodium chloride pusher centrifuge 221, following which, the wet sodium chloride solids may then be further processed (step 222). This may include steps of drying, screening, compacting, and/or briquetting. The brine produced from primary evaporation step 219 is then fed into a mix tank 227, where lime is added (step 228) and mixed therewith. The precipitates formed from this liming step (such as Mg(OH)₂ and CaSO₄) may be cycloned (step 230) and passed to a waste stream 231. The resulting brine from the liming step may then be subjected to a secondary evaporation step 234. The resulting slurry is passed to a drum 235 where calcium chloride precipitates out. The calcium chloride solid undergoes further processing (step 237), such as drying, screening and/or flaking, to form saleable calcium chloride. The brine resulting from the previous calcium chloride precipitation step, is passed to a mix tank, to which, sodium sulphate is added (step 240) and mixed therewith. This precipitates the remaining calcium ions as calcium sulphate. This mixture is cycloned (step 241). The waste solids can also be passed into the waste stream 231; the overflow brine is a lithium-rich brine 255. A soda ash solution is added (step 258) to the lithium-rich brine 255 and mixed together. Lithium carbonate is precipitated, which may be cycloned (step 261). The lithium carbonate undergoes further processing (step 264), such as centrifuging, drying, screening, compacting and/or flaking, to form saleable lithium carbonate.

The disclosed invention provides a process where lithium-bearing salt brines, even those that are relatively low in lithium concentration, may be utilised to extract lithium in the form of lithium carbonate in an economically viable manner. The process not only produces lithium carbonate, but also produces commercially useful and saleable products, sodium chloride and calcium chloride, which improve the economic viability of the overall process. Lithium carbonate of relatively good purity can be produced. Further, the process can be arranged in a manner that is energy and cost efficient, further improving the commercial viability thereof.

Table 2 below provides, as an example, the sample composition content of: the feed brine (see column A) at the start of the present process, and the brine (see column B) following the primary evaporation step. The composition of column B shows that 90.59% of the 100 litres of water that was in the feed brine has been removed. Following steps to remove Na, Mg, Ca as described herein, and further steps to concentrate the lithium content, there remains 2.6 litres of water (˜97.4% of the water that was in the feed brine having been removed), and ˜5000 mg/L of lithium.

TABLE 2
Brine Make-Up

| | A | B |
|---|---|---|
| Volume of Water | 100 litres | 9.41 litres |
| Total Volume | 105.89 litres | 23.73 litres |
| K (mg/L) | 5,100 | 54,222 |
| Mg (mg/L) | 2,010 | 21,370 |
| Na (mg/L) | 54,000 | 574,116 |
| Cl (mg/L) | 125,100 | 1,330,036 |
| Ca (mg/L) | 15,900 | 169,045 |
| SO₄ (mg/L) | 155 | 1,648 |
| Bicarbonate (mg/L) | 232 | 2,647 |
| Sr (mg/L) | 630 | 6,698 |
| B (mg/L) | 260 | 2,764 |
| Br (mg/L) | 426 | 4,529 |
| Li (mg/L) | 130 | 1,382 |

Further investigations regarding the primary evaporation step (step 119) were also conducted. It was contemplated that this primary evaporation step could be carried out in several different ways; for example, it could be carried out as a “One-Stage” process, a “Two-Stage” process or a “Four-Stage” process. Further testing and analysis were conducted regarding each of these. Sample results are presented in Tables 3-5 regarding the percentage recovery of certain elements after employing such evaporation step.

Table 3 below shows the sample analysis after using a one-stage evaporation step. 5 L of feed brine is heated to ˜203° F. with agitation to evaporate the water in the feed brine; the resulting precipitate was filtered out.

TABLE 3
One-Stage Evaporation

| | | | | Recovery |
|---|---|---|---|---|
| Sample | Feed brine | Filtrate | Solid | (%) |
| Weight | 5800 | 1097.29 | 825.27 | 18.9 |
| Li (ppm) | 71 | 346 | 58 | 92.2 |
| Mg (ppm) | 2918 | 12832 | 2623 | 83.2 |
| Na (ppm) | 60741 | 8085 | 359427 | 2.5 |
| K (ppm) | 4212 | 20112 | 4317 | 90.3 |
| Ca (ppm) | 24767 | 96416 | 223699 | 73.6 |
| Sr (ppm) | 1080 | 4609 | 857 | 80.7 |
| SO₄²⁻ (ppm) | 186 | 1728 | 1821 | 176.1 |
| Evaporated water (g) | 3650 | | | 63 |

Table 4 below shows the sample analysis after using a two-stage evaporation step. 5 L of feed brine is heated to ˜203° F. with agitation to evaporate the water in two stages; the precipitates were filtered out while hot at the end of the first stage; at the end of stage 2, precipitates formed after cooling down to room temperature and were filtered out; precipitates from the two stages were combined.

TABLE 4
Two-Stage Evaporation

| | | | | | Recovery |
|---|---|---|---|---|---|
| Sample | Feed brine | Filtrate | Solid 1 | Solid 2 | (%) |
| Weight | 5850 | 1071.13 | 760.52 | 27.66 | 18.3 |
| Li (ppm) | 71 | 293 | 63 | 29 | 75.6 |
| Mg (ppm) | 2918 | 11348 | 2834 | 1327 | 71.2 |
| Na (ppm) | 60741 | 8744 | 390214 | 3891015 | 2.6 |
| K (ppm) | 4212 | 17055 | 664 | 3487 | 74.1 |
| Ca (ppm) | 24767 | 88171 | 24943 | 14437 | 65.2 |
| Sr (ppm) | 1080 | 4060 | 933 | 525 | 68.8 |
| SO₄²⁻ | 186 | 1375 | 1678 | 7714 | 135.6 |
| (ppm) | | | | | |
| Evap- | 3889.86 | | | | 66 |
| orated | | | | | |
| water (g) | | | | | |

Table 5 below shows the sample analysis after using a four-stage evaporation step. 5 L of feed brine is heated to ˜203° F. with agitation to evaporate the water in four stages; the precipitate was filtered out while hot at the end of each stage; precipitates from the four stages were combined.

TABLE 4
Two-Stage Evaporation

| | | | | | | | Recovery |
|---|---|---|---|---|---|---|---|
| Sample | Feed brine | Filtrate | Solid 1 | Solid 2 | Solid 3 | Solid 4 | (%) |
| Weight | 5850 | 1104.39 | 87.48 | 356.96 | 158.50 | 118.97 | 18.9 |
| Li (ppm) | 71 | 305 | 11 | 17 | 30 | 44 | 81.1 |
| Mg (ppm) | 2918 | 11749 | 603 | 844 | 1447 | 2081 | 76.0 |
| Na (ppm) | 60741 | 10436 | 390214 | 389472 | 383538 | 377974 | 3.2 |
| K (ppm) | 4212 | 18384 | 83 | 1245 | 1328 | 1370 | 82.4 |
| Ca (ppm) | 24767 | 92169 | 4574 | 6861 | 13007 | 18117 | 70.3 |
| Sr (ppm) | 1080 | 4142 | 170 | 254 | 475 | 670 | 72.4 |
| SO₄²⁻ (ppm) | 186 | 1327 | 150 | 425 | 3924 | 3026 | 134.9 |
| Evaporated | 3657.53 | | | | | | 63 |
| water (g) | | | | | | | |

It was also found that sometimes, under certain conditions, the amount of water that could be evaporated from the feed brine was somewhat limited, due to the formation of a gel-like material, which interfered with any subsequent filtration steps. For example, as can be seen from the examples in tables 3-5 above, the amount of water removed in the primary evaporation step 119 is approximately 60%. Thus, the amount of water removed by evaporation from the primary evaporation step 119 is variable; preferably, the amount of water removed in the evaporation step is in the range of between ˜60-90%.

1. A process for producing lithium carbonate from a lithium-bearing salt brine, comprising the steps of:
(i) subjecting a feed brine containing lithium to a primary evaporation step, wherein a plurality of mechanical evaporators are used to evaporate water from the feed brine, thereby forming a first concentrated brine and sodium chloride;
(ii) separating the sodium chloride from the first concentrated brine in a salt removal step;
(iii) reacting lime with the first concentrated brine in a liming step, thereby forming a limed brine and a first discard precipitate comprising one or more of the group consisting of magnesium hydroxide and calcium sulphate;
(iv) subjecting the limed brine to a secondary evaporation step, wherein a plurality of mechanical evaporators are used to evaporate water from the limed brine, thereby forming a second concentrated brine and a precipitate of calcium chloride;
(v) separating the calcium chloride from the second concentrated brine;
(vi) reacting sodium sulphate with the second concentrated brine, thereby forming a lithium-rich brine and a second discard precipitate comprising calcium sulphate;
(vii) reacting soda ash with the lithium-rich brine, thereby forming a precipitate of lithium carbonate; and
(viii) separating the lithium carbonate.

2. The process of claim 1, wherein the feed brine is an industrial brine or oilfield brine.

3. The process of claim 1, additionally comprising a preheating step prior to the primary evaporation step, wherein the feed brine is preheated to a temperature of between 200° F. to 212° F.

4. The process of claim 1, wherein in the primary evaporation step, between 60% and 90% of the water in the feed brine is removed by evaporation.

5. The process of claim 1, wherein the salt removal step comprises one or more of cycloning, centrifuging, washing, drying the sodium chloride.

6. The process of claim 1, wherein the step of separating the calcium chloride from the second concentrated brine, comprises producing calcium chloride flake.

7. The process of claim 1, wherein the step of separating the lithium carbonate, comprises one or more of cycloning, centrifuging, washing, drying and compacting the lithium carbonate.

8. The process of claim 1, wherein each of the sodium chloride separated in the salt removal step of step (ii), the calcium chloride separated in step (v), and the lithium carbonate separated in step (viii) are collected for commercial sale.

9. The process of claim 1, wherein one or both of the first and second discard precipitates are further processed for discard, comprising one or more of cycloning, centrifuging, washing and drying.

10. A process for producing lithium carbonate from a lithium-bearing salt brine, comprising the steps of:
(i) subjecting a feed brine containing lithium to a primary evaporation step, wherein a plurality of mechanical evaporators are used to evaporate water from the feed brine, thereby forming a first concentrated brine and sodium chloride;
(ii) separating the sodium chloride from the first concentrated brine in a salt removal step;
(iii) reacting lime with the first concentrated brine in a liming step, thereby forming a limed brine and a first discard precipitate comprising one or more of the group consisting of magnesium hydroxide and calcium sulphate;
(iv) subjecting the limed brine to a secondary evaporation step, wherein a plurality of mechanical evaporators are used to evaporate water from the limed brine, thereby forming a second concentrated brine and a precipitate of calcium chloride;
(v) separating the calcium chloride from the second concentrated brine;
(vi) reacting soda ash with the second concentrated brine, thereby forming a lithium-rich brine and a second discard precipitate comprising calcium carbonate;
(vii) reacting soda ash with the lithium-rich brine, thereby forming a precipitate of lithium carbonate; and
(viii) separating the lithium carbonate.

11. A process for producing lithium carbonate from a lithium-bearing salt brine, comprising the steps of:
(i) subjecting a feed brine containing lithium to a primary evaporation step, wherein a plurality of mechanical evaporators are used to evaporate water from the feed brine, thereby forming a first concentrated brine and sodium chloride;
(ii) separating the sodium chloride from the first concentrated brine in a salt removal step;
(iii) reacting lime with the first concentrated brine in a liming step, thereby forming a limed brine and a first discard precipitate comprising one or more of the group consisting of magnesium hydroxide and calcium sulphate;
(iv) subjecting the limed brine to a secondary evaporation step, wherein a plurality of mechanical evaporators are used to evaporate water from the limed brine, thereby forming a second concentrated brine and a precipitate of calcium chloride;
(v) separating the calcium chloride from the second concentrated brine;
(vi) reacting a mixture of sodium sulphate and soda ash with the second concentrated brine, thereby forming a lithium-rich brine and a second discard precipitate comprising calcium carbonate and calcium carbonate;
(vii) reacting soda ash with the lithium-rich brine, thereby forming a precipitate of lithium carbonate; and
(viii) separating the lithium carbonate.
